(19) United States
(12) Patent Application Publication
(10) Pub. No.: US 2014/0365255 A1
(43) Pub. Date: Dec. 11, 2014

(54) SYSTEM AND METHOD FOR APPLYING PREDICITIVE ANALYSIS TO DETERMINE CLIENT SUPPORT REQUIREMENTS BY MEANS OF INDIRECT USER INTERACTION

(71) Applicant: C1 Bank, St. Petersburg, FL (US)

(72) Inventors: Trevor Burgess, St. Petersburg, FL (US); Marcio deOliveira, Sarasota, FL (US); Vasyl Borysovych Martyniuk, St. Petersburg, FL (US); Michael Claffey, St. Petersburg, FL (US); Kevin Foschini Moody, Lakewood Ranch, FL (US)

(73) Assignee: C1 Bank, St. Petersburgh, FL (US)

(21) Appl. No.: 14/263,151

(22) Filed: Apr. 28, 2014

Related U.S. Application Data
(60) Provisional application No. 61/831,935, filed on Jun. 6, 2013.

(51) Int. Cl. G06Q 30/00; G06Q 10/06

(52) U.S. Cl. CPC G06Q 30/016; G06Q 10/063112
USPC 705/7.14

(57) ABSTRACT

Systems and methods enable the processing of a customer-support request by allowing customers to initiate a support request through a computing device without the need for the customer to provide information relating to the customer's reasons for initiating the request. In one embodiment, a server associated with a provider receives a support request from a customer computing device. The provider server performs predictive analysis to determine the most likely reasons the customer initiated the service request. The provider server also identifies one or more representatives qualified to address the support request and transmits a support request notification to a computing device associated with a provider representative who is qualified to address the request.

### REFERENCE TO RELATED APPLICATION

This application claims priority from U.S. Provisional Application Ser. No. 61/831,935 filed Jun. 6, 2013. The entirety of this provisional patent application is incorporated herein by reference.

### TECHNICAL FIELD AND BACKGROUND

The present invention relates generally to the field of customer support, and more particularly, to a method and system for optimizing the initiation of customer-support requests by allowing customers to initiate a support request through an Internet-enabled device and by using predictive analysis to identify a customer's most likely needs so the support request can be routed to the customer-service representative most qualified to assist the customer.

Customer service is a key component of carrying on a successful business enterprise. Providing prompt, effective customer support improves the overall customer experience and enhances customer loyalty. In today's marketplace, the increasing sophistication of products and services has necessitated even higher levels of customer service, and the enhanced connectivity provided by high-speed data connections and portable electronic devices has increased consumer expectations regarding the availability of customer service and the prompt resolution of support requests.

Traditional methods of customer support utilize call centers staffed by trained representatives who field phone calls from customers. Customers expect the first representative they contact to possess the requisite knowledge and tools to address the customer's needs. To increase the probability that customers will reach an appropriately qualified representative, some call centers provide customers with menu options that broadly describe categories of potential support requests. However, the limited number and breadth of menu options may not accurately characterize a customer's needs, or worse, the options may not describe the customer's needs at all. As a result, customers may not be routed to an appropriately qualified representative, or they may be forwarded to multiple representatives before a problem is resolved. Additionally, once customers reach an appropriately-qualified representative, customers will likely be required to describe in detail the reason for a support request before the representative can begin identifying and resolving customer problems or assisting customers with other needs. These inefficiencies impact the quality of customer service by increasing response time and decreasing the accuracy of problem resolution.

Accordingly, it is an object of the present invention to provide a customer support method and system that optimizes the initiation of customer-support requests by allowing customers to initiate a support request through an Internet-enabled device and without the need for the customer to provide information relating to the customer's reasons for initiating the request. It is a further object of the present invention to provide a customer support method and system that utilizes predictive analysis to identify a customer's most likely reasons for initiating a support request without input from the customer other than customer identifying information, so the support request can be conveniently routed to the customer-service representative most qualified to address a customer's needs, and so the customer-service representative can contact the customer.

### SUMMARY

According to one embodiment of the invention, a method and system of processing a customer support request is provided. The method includes receiving by a server associated with a provider, a support request transmitted by a computing device associated with a customer. The provider server performs a predictive analysis to determine one or more reasons why the customer initiated the support request. The provider server also determines one or more provider representatives qualified to address the support request and transmits a support request notification to a computing device associated with a provider representative that is qualified to address the support request.

In another aspect of the invention, a method and system includes ranking by the provider server the reasons for the support request according to a probability of occurrence before transmitting the support request notification. The method and system also includes ranking the representatives according to a probability that the representative will be able to address request before transmitting the support request notification. In yet another aspect of the invention, a support request notification is transmitted by the provider server to a provider representative computing device associated with a provider representative with the highest probability of being able to address the request.

According to one embodiment, the predictive analysis is performed independent of information received from the customer computing device other than information that identifies the customer. In another feature of the invention, the predictive analysis includes performing a context analysis, an account activity analysis, and a trend analysis. The account activity analysis can generate probabilities that the customer can be categorized as new, growth, stable, or decline. The trend analysis may generate probabilities that the reason for initiating a support request can be classified as (i) a new account or product inquiry, (ii) an existing account or product inquiry, (iii) an account maintenance and support activity, or (iv) a technical support request.

### BRIEF DESCRIPTION OF THE DRAWINGS

Features, aspects, and advantages of the present invention are better understood when the following detailed description of the invention is read with reference to the accompanying figures, in which:

FIG. 1 is a schematic diagram of a customer service system according to one embodiment of the invention;

FIG. 2 is an exemplary display screen of an Internet-enabled device including an icon for launching the customer service application according to the present invention;

FIG. 3 is an exemplary home screen for initiating a customer-service request;

FIG. 4 is an exemplary display screen indicating that a customer-service request is being uploaded;

FIG. 5 is an exemplary display screen indicating a status update of a customer-service request;

FIG. 6 is an exemplary display screen indicating to the customer that the customer-service request has been received and that a return call will follow;

FIG. 7 is an exemplary display screen for canceling a customer-service request;

FIG. 8 is exemplary display screens including fields for entering customer information;

FIG. 9 is exemplary display screens including fields for entering customer information;

FIG. 10 is an exemplary display screen for confirming customer authentication;

FIG. 11 is an exemplary display screen for displaying failed customer authentication; and

FIG. 12 is a schematic diagram illustrating a method for predictive analysis of customer-service requests according to one embodiment of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

Disclosed herein is a method and system for optimizing the initiation of customer-support requests by allowing customers to initiate support requests through an Internet-enabled device, for example, by pressing a single button, and by using predictive analysis to identify a customer's most likely needs for purposes of routing the support request to the most qualified customer-service representative. Once the customer-service representative receives the support request, the representative can analyze information relevant to the request and directly contact the customer to address the customer's needs. The method and system requires minimal input from the customer other than identifying information. The system generally includes one or more separate hardware units with integrated software that implements the method of the present invention.

As used herein, the term provider generally describes the person or entity providing customer support. The term customer is intended to generally describe a purchaser of products or services who utilizes the method and system described herein for, among other purposes, seeking customer support. The term customer may be used interchangeably with the terms consumer, client, or user. The term “customer support” is used interchangeably with the terms support or customer service and generally includes, but is not limited to, providing customers with assistance in utilizing existing products and services and with purchasing additional products and services. The term representative generally describes an individual who interfaces with the customer to provide customer support, and the term is used interchangeably with associate.

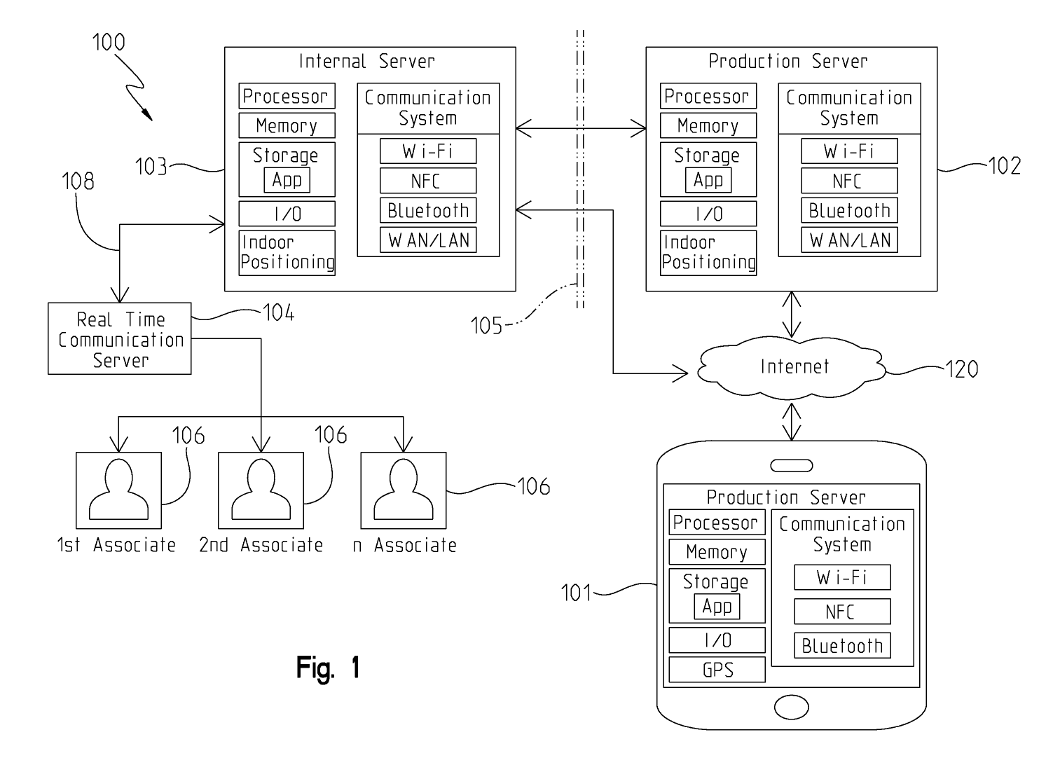

As shown in FIG. 1, a system according to one embodiment of the present invention generally includes a computing device 101 (e.g., an Internet-enabled device) operated by a consumer and a computer system associated with a provider 100. The provider's computer system 100 may include a production server 102, a firewall 105, an internal server 103, a real-time communication server 104, and one or more computing devices (not shown) operated by the provider associates 106. The system 100 shown in FIG. 1 is not intended to be limiting, and one of ordinary skill in the art will recognize that the method and system of the present invention may be implemented using other suitable hardware or software configurations. For example, the system 100 may utilize only a single server implemented by one or more computing devices or a single computing device may implement one or more of the production server 102, internal server 103, firewall 105, real-time communication server 104, and/or associate computing device. Further, a single computing device may implement more than one step of the methods described herein; a single step may be implemented by more than one computing device; or any other logical division of steps may be used.

The provider's computer system 100 may also include an indoor positioning system to gather information on the indoor location of a customer for use in predictive analysis, as described in more detail below. The indoor positioning system can be implemented using any suitable wireless communication system configured to communicate through radio frequency (“RF”), WI-FI (e.g., wireless local area network products based on the Institute of Electrical and Electronics Engineers 802.11 standards), near field communications (“NFC”), BLUETOOTH®, or Low Energy BLUETOOTH. The indoor positioning system receives a wireless signal from a consumer computing device and determines its location using radiolocation techniques such as, for example, the time difference of arrival (“TDOA”) method, the angle of arrival (“AOA”) method, the received signal strength indicator (“RSSI”) method, the link quality (“LQ”) method, or signature-based location methods.

In a preferred embodiment, the consumer computing device 101 is a portable electronic device that includes an integrated software application configured to operate as a user interface and to provide two-way communication with the provider's computer system 100. The portable electronic device can be any suitable type of electronic device, including, but not limited to, a cellular phone, a tablet computer, or a personal data assistant. As another example, the portable electronic device can be a larger device, such as a laptop computer. The portable electronic device can include a screen and one or more buttons, among other features. The screen can be a touch screen that includes a tactile interface.

Any suitable computing device can be used to implement the consumer computing device 101 or the components of the provider's computer system 100. The consumer computing device 101, the provider's servers 102-104, and the associate computing devices may include a processor that communicates with a number of peripheral subsystems via a bus subsystem. These peripheral subsystems may include a storage subsystem, user-interface input devices, user-interface output devices, a communication system, a network interface subsystem, and a Global Positioning System (“GPS”). By processing instructions stored on one or more storage devices, the processor may perform the steps of the present method. Any type of storage device may be used, including an optical storage device, a magnetic storage device, or a solid-state storage device.

Typically, the consumer computing device 101 accesses the providers computer system 100 over the Internet 120 in the normal manner—e.g., through one or more remote connections, such as a Wireless Wide Area Network (“WWAN”) based on 802.11 standards or a data connection provided through a cellular service provider. These remote connections are merely representative of a multitude of connections that can be made to the Internet 120 for accessing the provider's computer system 100.

It should be understood by those skilled in the art that although the present disclosure refers generally to GPS devices, the term GPS is being used expansively to include any satellite-based navigation system, such as the Galileo system, the GLONASS system, or the BeiDou Satellite Navigation System. Furthermore, references to GPS include both Assisted GPS and Aided GPS devices. Those skilled in the art will also recognize that other types of positioning systems can be used to implement the present invention, including, for example, radiolocation systems using the TDOA method, the AOA method, or signature-based location methods.

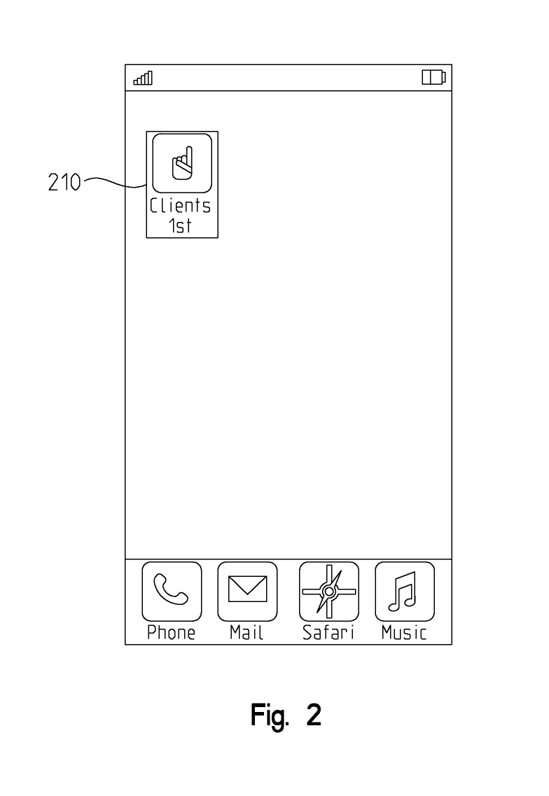

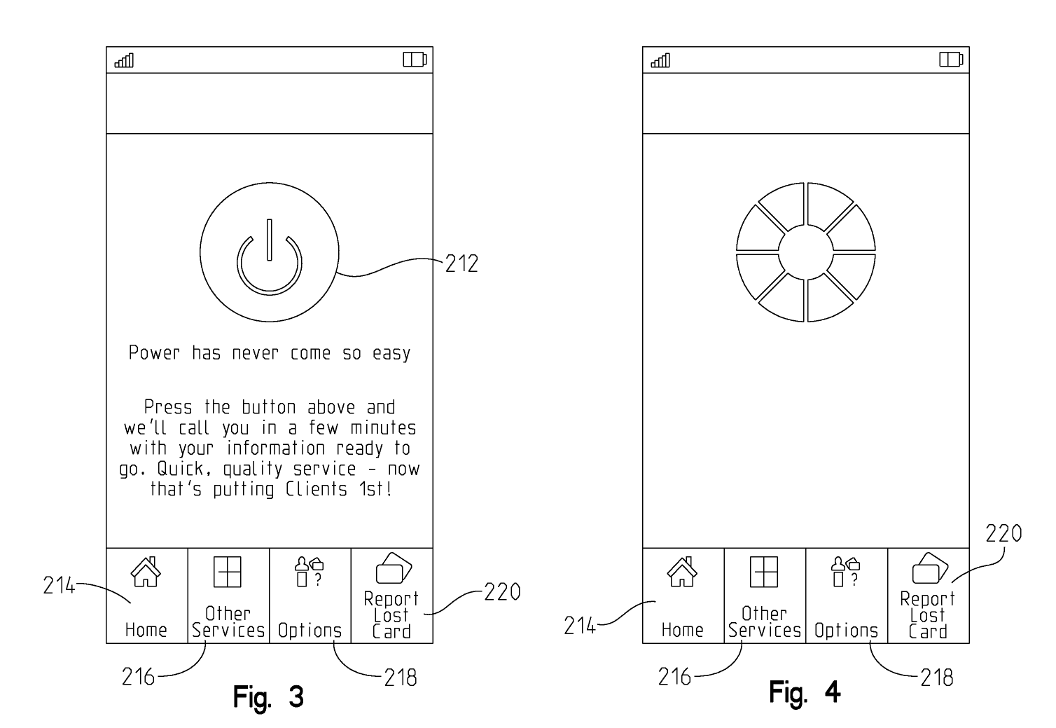

As in the embodiment shown in FIG. 1, the consumer computing device 101 may be a cellular smartphone configured to achieve two-way communication with the provider's production server 102 during the initiation of a support request 301. The support request 301 is initiated using a software application integrated with the smartphone. The application can be accessed, for example, by clicking or tapping on an icon located on a touch screen of the smartphone, such as the start icon 210 shown at the top of the screen in FIG. 2. FIGS. 3-11 generally depict examples of user-interface screens and functions available through the application. For example, as show in FIG. 3, a customer may conveniently initiate a support request 301 with a single click by tapping the main function 212 located on a home screen.

In other embodiments, a support request 301 is initiated automatically using an indoor positioning system that recognizes the consumer computing device 101 and establishes a connection when the consumer computing device 101 is proximate to the provider's computer system 100, such as when a customer enters a branch or retail location of the provider. In this embodiment, predictive analysis is used to identify a customer's most likely needs for purposes of routing 308 the support request to a qualified associate 106, as described in more detail below. An associate 106 can contact the customer by phone or in person by locating the customer within the branch or retail location and engaging the customer face to face. Alternatively, the reason for the support request can be saved to a database on the provider's internal server 103 and associated with the customer so that an associate 106 can quickly and conveniently retrieve this information if approached by the customer while inside the branch or retail location.

Turning to the user-interface screens of the application illustrated in FIGS. 4-6, these screens provide customers with information regarding the status of a support request 301, including whether the request 301 is “processing,” “under review,” “assigned,” or whether an associate 106 will soon contact the customer. Other functions may include the Home 214, Other Services 216, Options 218, and Report Lost Card 220 functions accessible through the icons at the bottom of FIGS. 3-6 or the Cancel Request function 222 shown in FIG. 5.

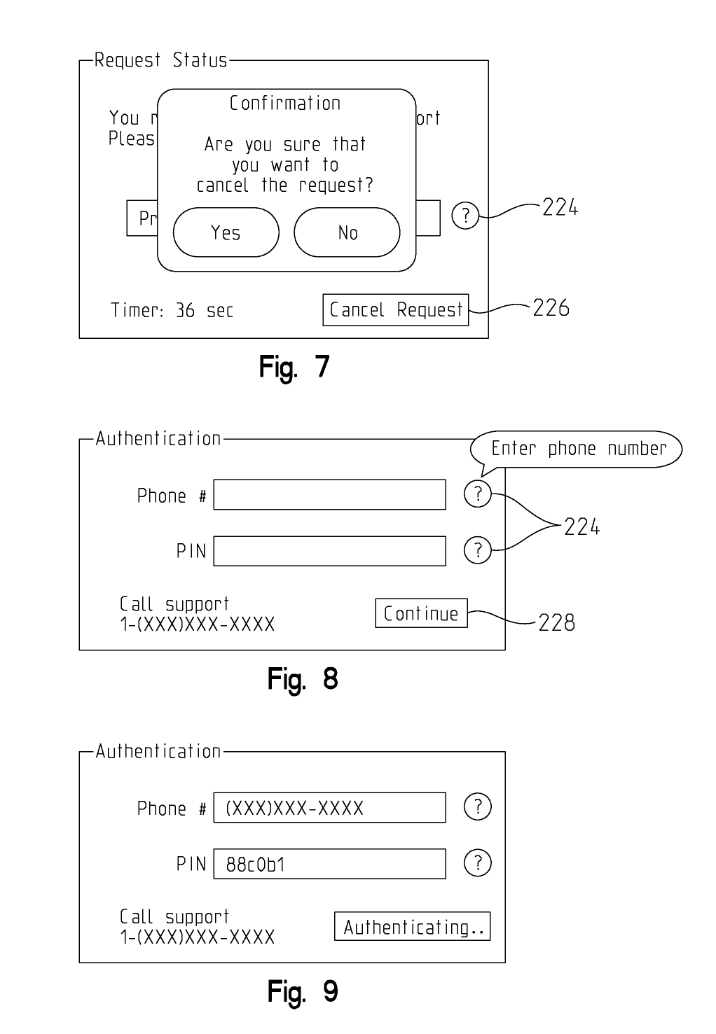

In the event the customer selects the Cancel Request function 222, the application may optionally display a notification, such as the one shown in FIG. 7, which requires the customer to select Yes or No to confirm the Cancel Request 222. If the customer has navigated to other user-interface screens within the application, then selecting the Home function 214 may display the home screen where the customer can initiate a support request 301. Alternative means for initiating a support request 301 can optionally be provided through the Options 218 or Report Lost Card functions 220, which allow customers to bypass the predictive analysis step described herein and to contact associates responsible for assisting customers with issues such as technical support or lost debit or credit cards. The user-interface screens can also include a help function 224 available by selecting the question mark (“?”) shown in FIGS. 7-11. The help function 224 assists the customer by providing a brief explanation of the different data-entry fields on a user-interface screen. Other methods of assisting a customer may be provided through the help function 224, such as directing the customer to a webpage or displaying a document that provides customers with useful information. One skilled in the art will appreciate that these examples of functions and user-interface screens are not intended to be limiting, and the application may include other screens, functions, or information useful to the customer.

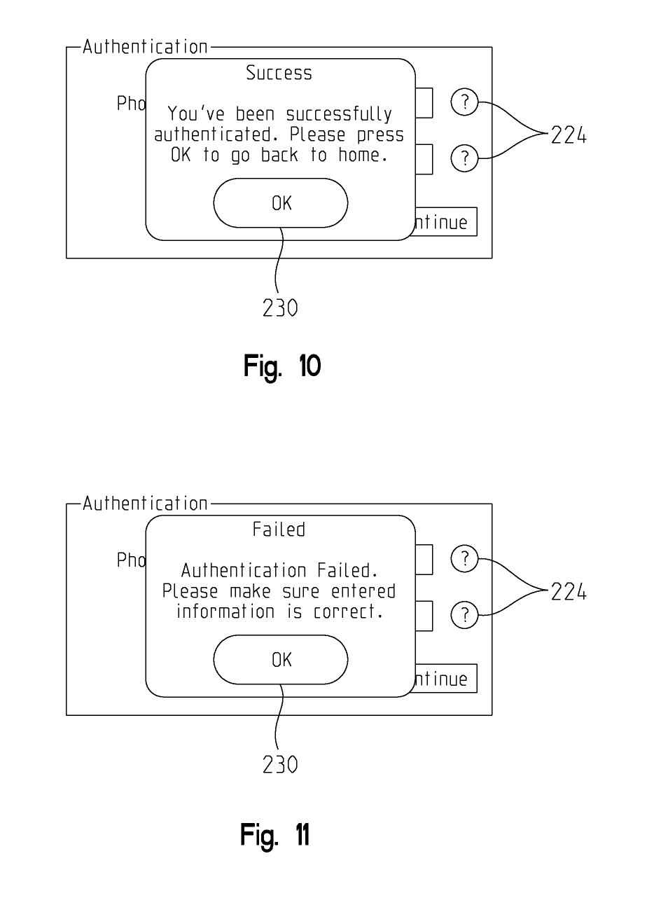

Each support request 301 is generally associated with a particular customer to provide for accurate results from the predictive analysis as well as increased security with regard to the connection between the consumer computing device 101 and the provider's computer system 100. In the embodiments shown in FIGS. 7-11, the support request 301 is associated with a particular customer by authenticating the request 301 using the customer's phone number and a personal identification number (“PIN”). If the customer is not authenticated, then upon initiating a support request 301, the application may prompt the customer to enter a phone number and a PIN, as shown in FIGS. 8 & 9. By selecting the Continue function 228 shown in FIG. 8, the phone number and PIN can be transmitted to the provider's computer system 100 for authentication. In one embodiment shown in FIG. 9, the application may optionally notify the user that the authentication request was submitted by displaying a notification that reads, for example, “Authenticating.”

If the authentication is successful—that is, the phone number and PIN are associated with a valid customer account—then the application may display a notification, such as the one shown in FIG. 10, indicating that the authentication succeeded. The customer may be required to acknowledge the notification by selecting the OK function 230 before continuing. If the authentication succeeds, the provider's computer system 100 may also generate a token, or cookie, that contains customer-specific information and that is sent to and stored on the customer's computing device 101 for future use. The consumer computing device 101 may then attach the cookie to subsequent communications, which allows subsequent support requests 301 to be authenticated without the need to reenter the customer's phone number and PIN.

On the other hand, the authentication may fail, for example, if the customer provides an incorrect phone number or PIN or if there is a problem with the transmission of data between the consumer computing device 101 and the provider's computer system 100. If the authentication fails, the application may optionally display a notification, such as the one shown in FIG. 11, to indicate to the customer that the authentication was unsuccessful. Again, the customer may be required to acknowledge the notification by selecting the OK function 230 before continuing. The embodiment shown in FIGS. 8 & 9 provides the customer the option of exiting the authentication process and calling customer support using the support phone number displayed.

Referring again to FIG. 1, after a support request 301 is authentication, additional information can optionally be transmitted to the production server 102 and associated with the support request 301, such as the geographic position or indoor location of the customer or information about the request 301 input by the customer. The support request 301 may be stored on the production server 102 as a database record that includes the customer's token, a support request identification number, the time of the support request 301, the status of the support request 301, the geographic or indoor location of the customer, or any other useful information.

The internal server 103 may periodically poll the production server 102 using a software process running on the internal server 103 to determine if a new support request 301 has been initiated or if an existing support request 301 has been modified or cancelled. Upon detecting a new support request 301, the internal server 103 may fetch the new support request 301 and store it as a database record on the internal server 103 for processing, or if an existing support request 301 has been modified or cancelled, the internal server 103 may update or delete the database record accordingly.

The support request 301 can be processed using predictive analysis to determine the most likely reasons that the customer initiated the support request 301. Predictive analysis allows the support request 301 to be routed 308 to the associate 106 most qualified to resolve the request 301 without the need for a customer to enter information other than information sufficient to identify the customer. This is an improvement over existing customer support methods and systems, which require customers to describe in some detail the reason for a support request 301 or to categorize their support request 301 using a limited number and breadth of menu options provided.

Predictive analysis methods may include analyzing historical and current facts to make predictions about future events. Predictive analysis may encompass a variety of techniques, including statistical modeling, trend analysis, data mining, or self-learning. For example, a predictive analysis model may capture the causal relationship between facts and variables and assign each causal relationship a conditional dependence defined by a probability function. Predictive analysis models can be represented by weighted coefficient matrices where the weights correspond to the effect of various predictors on possible outcomes. The analysis may also incorporate self-learning techniques where new data is periodically entered into, or automatically gathered by, a system to recalculate the weights or probabilities used in the underlying mathematical model. This allows the system using predictive analysis to be continually updated and to pick up on new trends.

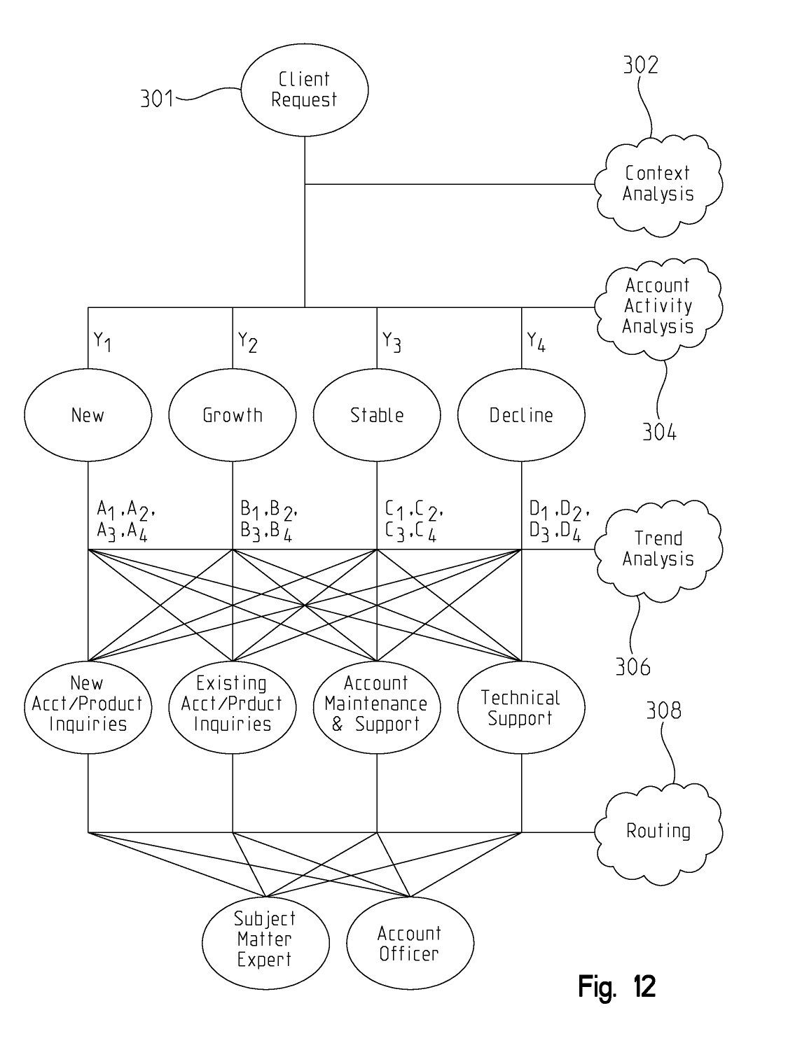

An exemplary predictive analysis approach is illustrated in FIG. 12. The approach illustrated in FIG. 12 utilizes three sequential components and is particularly suited for use by a provider that offers customer support in the banking and financial services industry. Each component is a separate analysis that considers various factors, or predictors. In conducting the analysis, each predictor is assigned a weight that determines the effect of the predictor on the outcome of the analysis. The weight of each predictor can be calculated based on predictor data stored in one or more databases on the provider's computer system 100. With respect to a provider in the banking and financial services industry, information stored on the provider's computer system 100 may include: customer account types and balances; the number and amount of account deposits and withdraws; the dates that certain accounts were created; the geographic location of the customer; whether particular associates have been previously assigned to assist a particular customer; or any other suitable information collected or generated by the provider.

Although the exemplary analysis illustrated by FIG. 12 is described with reference to the banking and financial services industry, FIG. 12 is not intended to be limiting. Those skilled in the art will recognize that the analysis may be modified to accommodate different providers in different industries by, for example, including more or less analytical components, considering different predictors, or varying the mathematical models and methods used.

The first component in the exemplary predictive analysis approach shown in FIG. 1 is performing a context analysis 302. Context analysis 302 examines the circumstances and activities of the customer to optimize the presentation and content of information and to improve the accuracy of the predictive analysis. The inputs to the context analysis include, among other data, the geographic location of the customer, the indoor location of the customer, and prior-behavior context triggers. The geographic location of the customer can be determined using a GPS device integrated with the consumer computing device 101, and the indoor location of a customer can be determined using an indoor positioning system integrated with the provider's computer system 100. Prior-behavior context triggers can be determined by examining customer account information, such as the frequency, type, and circumstances of prior transactions.

The second component of the approach shown in FIG. 12, account activity analysis 304, categorizes customers initiating a support request 301 into one of four categories based on the customer's relationship with the provider and level of activity using the provider's services. The account activity analysis 304 considers predictors such as: client relationship management (“CRM”) activities; average account balances; account creation dates; the type of the most recent transaction by the client; profitability of the customer's accounts; product maturity; account balance variations; activity-level variations; detected error conditions or flags; or the types of products held by the customer. Based on these predictors, the account activity analysis 304 generates probabilities Y₁, Y₂, Y₃, Y₄, which correspond respectively to the probabilities that a customer may be categorized as New, Growth, Stable, or Decline.

The third component, trend analysis 306, categorizes the potential reasons for the support request 301 by considering both customer-specific predictors as well as predictors reflecting overall trends with the provider's services across all customers. The trend analysis 306 includes predictors such as: the number and type of prior support requests 301 by a particular customer; the aggregate number and type of support requests 301 by all customers; the types of products that are the subject of support requests 301; detected error conditions or flags; product maturity; discrepancies between the interest rates of various products; or current promotions offered by the provider. Based on these predictors, the trend analysis 306 generates probabilities A₁ to A₄, B₁ to B₄, C₁ to C₄, and D₁ to D₄, which correspond to the probabilities that a particular category of customer is initiating a support request 301 that can be categorized as one involving: new account and product inquiries; existing account and product inquiries; account maintenance and support activities; or technical support. These probabilities are used to determine a list of the most likely reasons that the customer initiated the support request 301, which can be ranked according to the probability of occurrence.

Once the most likely reasons for the support request 301 are identified, the support request 301 can be routed 308 to the associate 106 most qualified to resolve the request 301. An algorithm may be used to identify one or more associates 106 that are qualified to resolve the support request 301. The associates 106 can optionally be ranked according to the likelihood that the associate 106 is qualified to solve the support request 301 or ranked according to some other criteria that establishes a preferential order for associates 106. Identifying or ranking more than one associate 106 allows the system to route 308 the support request 301 to the next most-qualified associate 106 in the event the most-qualified associate 106 is unavailable or the support request 301 is for some reason not addressed by an associate 106 within a specified amount of time. The algorithm for identifying or ranking associates 106 may consider factors such as, but not limited to: the type of product that is the subject of the support request 301; the associate's 106 officer code, or type of services the associate 106 is responsible for providing; the geographic location of the associate 106; the availability of the associate 106; or the subject-matter expertise of the associate 106.

After one or more qualified associates 106 are identified, the identities can be stored in the internal server 103 database record associated with the support request 301. The internal server 103 can then initiate a support-request notification 108 that is sent to the associate's computing device using the real-time communication server 104 illustrated in FIG. 1. The real-time communication server 104 may be implemented using a separate computing device with integrated software, or it may be a software application running on the internal server 103, such as the LYNC® real-time communications platform made by Microsoft Corporation of Redmond, Wash. The associate 106 may receive the support-request notification 108 as a text message displayed by a software process running on the associate's computing device, such as the LYNC client that is part of the LYNC real-time communications platform.

The support-request notification 108 can include a variety of information useful to the associate 106, such as the type of support request 301 or a link to the customer's profile page containing information about: the types of products owned by the customer; customer transaction history; customer account balances; or the most likely reasons for initiating the support request 301 ranked according to the probability of occurrence. The associate 106 can then analyze the information included with the support-request notification 108 as well as any other pertinent information before accepting the support request 301 and contacting the customer.

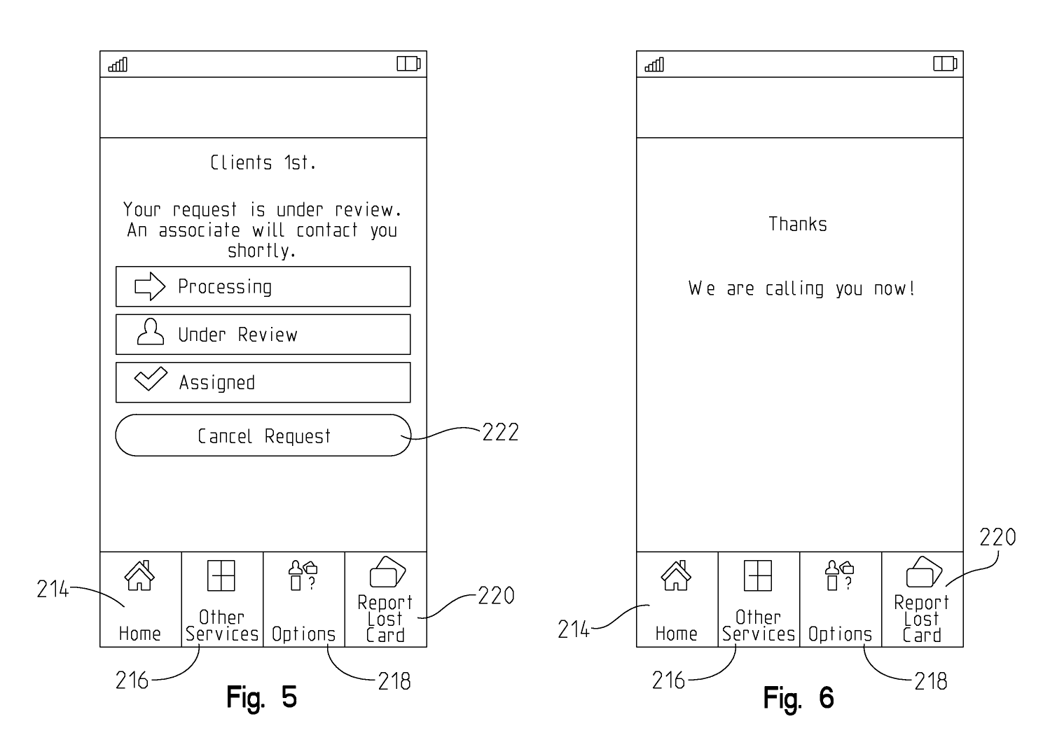

Referring again to FIGS. 4-6, the application integrated with the consumer computing device 101 may provide customers with information regarding the status of a support request 301 during the different stages of the process. For instance, the user-interface screen shown in FIG. 4 may be displayed after a support request 301 is initiated and before the request is fetched by the internal server 103. The user-interface screen show in FIG. 5 may display processing after the support request 301 has been stored to a database on the internal server 103 and while it is being processed using predictive analysis or routed 308 to an associate 106. The user-interface screen shown in FIG. 5 may also display “under review” after the support-request notification 108 is sent to an associate 106 and while the associate 106 is analyzing the information included with the support-request notification 108. And the user-interface screen show in FIG. 5 may updated to “assigned” or the user-interface screen illustrated in FIG. 6 may be displayed after a support request 301 has been accepted by an associate 106 and before the associate 106 attempts to contact the customer.

The predictive analysis approach and routing method described herein may be better understood with reference to the following simplified examples. With respect to the context analysis 302, if customer account information reveals that a particular customer initiates a wire transfer to the same entity or account (e.g., a mortgage or utility payment) on the 15th day of every month, and the support request 301 is initiated on the 15th day, then this information can be used as a prior-behavior context trigger indicating that the support request 301 is related to this wire transfer. This prior-behavior context trigger would then weigh more heavily in the predictive analysis than if the support request 301 had been initiated on the 1st day of the month.

As another example, the prior-behavior context trigger can be used in conjunction with indoor positioning data. To illustrate, assume that indoor positioning data and prior account activity shows that a customer deposits a check on the third Tuesday of every month at a given retail location of a provider. If a support request 301 is initiated on the third Tuesday of a month, then not only can it be determined that the support request 301 is more likely to be related to the deposit, but the support request 301 is more likely to be routed to an associate 106 in the given provider retail location. In yet another example, if geographic position of the customer is Barcelona Spain, and the trend analysis 306 indicates that the customer has recently initiated multiple debit card transactions, then it can be predicted with a high degree of certainty that the support request 301 is related to the customer's use of a debit card in Barcelona.

Regarding the account activity analysis 304, if a provider recently attempted to call a customer in connection with a CRM activity but was unable to reach the customer, then the provider may be expecting a return call from the customer. Consequently, the CRM predictor would weigh more heavily in the account activity analysis 304 if the same customer subsequently initiated a support request 301 so that it would be more likely the support request 301 would be routed 308 to the associate 106 that attempted to contact the customer.

As to the trend analysis 306, if a provider is currently receiving an increased volume of support requests 301 related to an error with the provider's website, then the error flags predictor might weigh more heavily in the trend analysis 306, and a support request 301 might be more likely to be routed 308 to an associate 106 with subject matter expertise in technical support or website operations. As a further example, if the provider is currently running a promotion on a product owned by a customer initiating a request, then the events/promotions predictor might weigh more heavily in the trend analysis 306, and the support request 301 is more likely to be routed 308 to an associate 106 that serves as an account officer for the product subject to the promotion. Of course, these are just a few examples of support request routing 308 assuming the existence a particular condition, and one skilled in the art will recognize that numerous other outcomes are possible if, for example, multiple conditions exists that cause other predictors to weigh more heavily in the predictive analysis.

The method and system of the present invention may optionally incorporate other features, such as manual and automated self-learning techniques to continually or periodically update system information and to allow the system to recognize trends in the available data. For instance, the provider's computer system 100 can automatically monitor and capture information available at each stage of the process, including, but not limited to, information relating to: the number and type of support requests 301 initiated across all customers; customer input or selections; the amount of time between the initiation of a customer-support request 301 and when an associate 106 contacts the customer; and/or the amount of time it takes to resolve a customer's support request 301. Additionally, the system can be manually updated by, for example, allowing associates 106 to input information relating to the support request 301 and its resolution through a website or other user-interface portal on the associate's computing device. The information collected or generated by the provider may be stored in the provider's databases and used to recalculate the weights assigned to each predictor and the probabilities used in the mathematical models underlying the predictive analysis. The information may also be used to update the factors used in the algorithm for assigning 308 the support request 301 to the most-qualified associate 106, or in any other model or algorithm utilized in implementing the present invention.

The method and system of the present invention may also include features and contingencies that further optimize system operation or ensure continued operation in the event that one or more of the steps fails or yields a result that is outside of certain acceptable tolerances defined by the provider. As an example, if the predictive analysis yields a result indicating that there are two almost equally likely reasons for initiating the support request 301, the software application may display a user-interface screen on the consumer computing device 101 prompting the customer to enter information that would allow routing 308 of the support request 301 to the most-qualified associate 106. The method and system can also incorporate functions that bypass the predictive analysis and take a particular action upon the detection of a predefined condition, such as routing 308 a support request 301 to an associate 106 who is dedicated to assisting a particular class of customers of which the initiating customer is a member, such as new or high-value customers.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A computer-implemented method of processing a customer-support request, comprising:
(a) receiving by a server associated with a provider, a support request transmitted by a computing device associated with a customer;
(b) performing in the provider server, a predictive analysis to determine one or more reasons for initiating the support request;
(c) determining by the provider server, one or more provider representatives qualified to address the support request; and
(d) transmitting by the provider server a support request notification to a computing device associated with a provider representative that is qualified to address the support request.

2. The method of claim 1 further comprising the steps of:
(a) ranking by the provider server, the reasons for the support request according to a probability of occurrence before transmitting the support request notification; and
(b) ranking by the provider server, the provider representatives according to a probability that the provider representatives will be able to address the support request before transmitting the support request notification.

3. The method of claim 2 wherein the support request notification is transmitted by the provider server to a provider representative computing device associated with a provider representative with the highest probability of being able to address the request.

4. The method of claim 1 wherein the predictive analysis is performed independent of information received from the customer computing device other than information that identifies the customer.

5. The method of claim 1 where the predictive analysis comprises the steps of:
(a) performing a context analysis;
(b) performing an account activity analysis; and
(c) performing a trend analysis.

6. The method of claim 5 wherein the account activity analysis generates probabilities that the customer is new, growth, stable, or decline.

7. The method of claim 5 wherein the trend analysis generates probabilities that the reason for initiating a support request can be classified as (i) a new account or product inquiry, (ii) an existing account or product inquiry, (iii) an account maintenance and support activity, or (iv) a technical support request.

8. A system for processing a customer support request comprising:
a first processor associated with a provider;
a second processor associated with a customer;
one or more processors associated with provider representatives; and
a data storage device including a computer-readable medium having computer readable code for instructing the processors, and when executed by the processors, the processors perform operations comprising:
(a) receiving by the first processor, a support request transmitted by the second processor;
(b) performing by the first processor, a predictive analysis to determine one or more reasons for initiating the support request;
(c) determining by the first processor one or more provider representatives qualified to address the support request; and
(d) transmitting by the first processor a support request notification to a provider representative processor associated with a provider representative that is qualified to address the support request.

9. The system of claim 8 wherein the first processor is configured to:
(a) rank the reasons for the support request according to a probability of occurrence before transmitting the support request notification; and
(b) rank the provider representatives according to a probability that the provider representatives will be able to address the support request before transmitting the support request notification.

10. The system of claim 8 wherein the first processor is configured to transmit the support request notification to a processor associated with a provider representative with the highest probability of being able to address the request.

11. The system of claim 8 wherein the predictive analysis is performed independent from information received from the second processor other than information that identifies the customer.

12. The system of claim 8 wherein as part of the predictive analysis the first processor is configured to perform the steps of:
(a) performing a context analysis;
(b) performing an account activity analysis; and
(c) performing a trend analysis.

13. The system of claim 12 wherein the account activity analysis generates probabilities that the customer can be categorized as new, growth, stable, or decline.

14. The method of claim 12 wherein the trend analysis generates probabilities that the reason for initiating a support request can be classified as (i) a new account or product inquiry, (ii) an existing account or product inquiry, (iii) an account maintenance and support activity, or (iv) a technical support request.
